(19) United States
(12) Patent Application Publication
(10) Pub. No.: US 2014/0046718 A1
(43) Pub. Date: Feb. 13, 2014

(54) METHOD AND SYSTEM FOR QUEUE CONTROL

(71) Applicant: Richard Schiller, Chichester West Sussex (GB)

(72) Inventor: Richard Schiller, Chichester West Sussex (GB)

(73) Assignee: Q-MATIC AB, Molndal (SE)

(21) Appl. No.: 14/000,426

(22) PCT Filed: Mar. 1, 2012
(86) PCT No.: PCT/SE2012/050233

§ 371 Date: Oct. 28, 2013

Related U.S. Application Data
(60) Provisional application No. 61/447,723, filed on Mar. 1, 2011.

(51) Int. Cl. G06Q 10/10

(52) U.S. Cl. CPC G06Q 10/1097
USPC 705/7.21

(57) ABSTRACT

System comprising a queue control unit (10) and a device (12) that is arranged to send a request (14) from a requester (24) for a specified service to said queue control unit (10). The queue control unit (10) is arranged to provide, to said device (12), place and time information indicating the place to which said requester (24) is to go to receive said specified service and the time at which said requester (24) is to go to said place if he/she wants to be prioritised for receiving said specified service.

### TECHNICAL FIELD

The present invention concerns a system comprising a queue control unit and a method for providing an expedited specified service. The present invention also concerns a computer program product containing computer program code means arranged to cause a computer or a processor to execute the steps of such a method.

### BACKGROUND OF THE INVENTION

Queue areas are places in which people stand in one or more lines for goods or services. Physical queuing is sometimes replaced by virtual queuing, whereby a person requests and receives a place in a queue, by taking a numbered ticket from a machine for example. The queuer is then free to roam while he/she waits.

One way of reducing queue size is to make people book ahead and provide them with an appointed time to arrive to receive goods or services. This evens out the unpredictability of customer arrival times at the place providing goods or services. Appointment booking works when people plan in advance but does not work when they plan spontaneously or when their opportunity to acquire goods or services only becomes clear shortly before the time when they acquire them.

U.S. Pat. No. 7,516,148 discloses a system for assigning and managing patron reservations to one or mo re of a plurality of attractions, which receives reservation requests at hand-held, wireless personal communication devices (PCDs) that are provided to each patron. Reservation requests are transmitted to a computer associated with the selected attraction, which determines a proposed reservation time based on information describing the attraction, previously-made reservations maintained in a virtual queue, and the current state of a physical queue associated with the attraction. A proposed reservation time is transmitted to the PCD for confirmation or rejection by the patron. Confirmed reservations are entered in the virtual queue. Patrons are alerted by the PCD when their reservation time is approaching.

Such as system allows users to find out waiting time forecasts and get in a queue for a particular attraction before arriving at the attraction, while roaming freely and allows them to time their arrival to the availability of attraction. A disadvantage with such a system is that each user has to be provided with such an application specific pager which he/she has to carry, which can be troublesome and costly and which is also disadvantageous from a public health perspective, as there is a shared device changing hands.

Queues have also begun to be replaced by mobile queues whereby the person queuing uses his/her phone, the internet, a kiosk or another method to enter a virtual queue, optionally prior to arrival and then gets paged at his/her mobile phone when his/her turn approaches. A disadvantage with such a system is that it can generate a lot of traffic on a wireless communication network which may cause communication delays or breakdowns in the communication network. Furthermore, such a queuing system is only available to people that have access to a mobile phone.

### SUMMARY OF THE INVENTION

An object of the invention is to provide an improved queuing system.

This aim is achieved us achieved by a system comprising a queue control unit and a device that is arranged to send a request from a requester for a specified service to the queue control unit via a communication network. The queue control unit is arranged to provide, to the device, place and time information indicating the place to which the requester is to go to receive the specified service and the time at which the requester is to go to the place if he/she wants to be prioritised for receiving the specified service.

A requester requests a specific service by sending a request from a device, the queue control unit will then send information concerning where the requester should go and at which time he/she should be there. The device is not used as a pager but merely as a means to allow a requester to join a queue before arriving at a place where he/she can receive a specified service. The number and availability of staff or the number and availability of equipment, such as counters or devices needed during the requester's transaction may be taken into account when selecting the best place to send the requester.

The requester may for example use his/her mobile phone or any other mobile or non-mobile communication device to connect to a queue control unit, by sending an e-mail, an SMS or any other signal thereto. The requester expresses which service or services he/she would like to receive, by selecting at least one service from a menu or list for example. The queue control unit can then inform the requester which one or more of the places that provide that at least one service would be the best to go to. The queue control unit may send the requester to a place that is further away than the closest possible choice of place, but where the waiting time would be shorter for the requested service. A place may also be chosen depending on the availability of staff or equipment to service the requester's request and/or the skill level of the staff available at a particular place to provide the service(s) requested. A requester may need to go to a plurality of places, whereby the queue control unit will provide a list of places and times to the requester's device.

Such a system will reduce queue size and less space will consequently be required for queues, which will result in savings in terms of costs such as rent and heating.

The expression “service” as used in this document is intended to mean any work provided by a person and/or establishment that serves; the purchase, repair or maintenance of goods; a meeting; or any activity for which people may queue for.

The “place to which the requester is to go to receive the specified service” is any establishment providing goods or services, such as a bank, shop, post office, restaurant, medical organization. It should be noted that in order to receive a specified service, a requester's physical presence need not necessarily be required. The “place to which the requester is to go to receive the specified service” can therefore be somewhere where a requester can be reached, by telephone, or by Skype or some other communication means.

According to an embodiment of the invention the queue control unit is also arranged to directly receive a request for a specified service from a requester without a device. For example, a queue control unit may be arranged to provide a requester with a place in a queue, by providing a numbered ticket to the requester for example. It should be noted that a queue control unit may be located at a place to which the requester is to go to receive a specified service, or it may be in communication with a ticket machine located at a place to which the requester is to go to receive a specified service. A remote queuing system, in which a requester may join a queue before arriving at a place where he/she is to receive a specified service and thereby use the time he/she spends getting to the place as part of the wait for the service, may thereby be combined with a physical or virtual queuing system whereby people may walk into a place offering at least one service, such as the branch of a bank, to use the service(s) thereof. A paper ticket queuing system may thereby be combined with a non-paper-ticket queuing system rather than choosing one or the other.

The system according to the present invention is designed to combine the advantages a completely planned and booked appointment system and a system that allows people to turn up spontaneously at a branch. It is designed to allow customers to make spontaneous decisions to attend a store but to reduce their waiting time in the branch and use the time they spend getting to the store as part of the waiting time. It allows the customer to use additional waiting time if there is any in useful activities like browsing in the branch or browsing in the branch of another store while they are waiting to attend the branch.

When a requester that has requested a specified service arrives at the place providing the service, the system according to the present invention may be arranged to register his/her arrival. The system may be arranged to check if the requester has arrived ahead of their allocated time. If not, then the requester is put in the queue as the next customer to be called ahead of customers who did not use the pre-arrival queuing system, but behind any requesters who did use the pre-arrival system and had earlier estimates than the one allocated to the requester in question.

According to another embodiment of the invention the device is a mobile device, such as a mobile telephone, media player, Personal Communications System (PCS) terminal, Personal Data Assistant (PDA), laptop computer or palmtop receiver.

According to a further embodiment of the invention the device comprises a timer, such as a countdown clock, that is arranged to be initiated when the device receives the place and time information. A device application may for example initiate the timer when the requester should start their journey to the place to which he/she is to go to receive a service, or immediately on receiving place and time information from the queue control unit. If communication with the queue control unit is lost, a requester will still be aware of the time at which he/she is to arrive. Such a solution reduces the amount of traffic on a communication network as compared to a pager systems in which at least one message is sent to the pager to remind its user of an appointment.

According to an embodiment of the invention the device comprises location determining means and means to send the location of the device to the queue control unit. The information concerning the location of the device is sent to the queue control unit together with the request, after sending the request, periodically after receiving the place and time information, or on request. The location of a requester may be identified using locating means such as a GPS receiver. According to an embodiment of the invention, the queue control unit may be arranged to advise or direct the requester to the place to which he/she is to go to receive a specified service.

According to another embodiment of the invention the system comprises identifying means to identify the requester when he/she arrives at the place to receive the specified service. The requester's request may comprise a photograph of the requester which may be sent to the place to which the requester is to go to receive a specified service, so that the service-providing staff can recognize the requester. Detection of a device's presence or location, using sensors or a GPS system or other geo-location capability built into a requester's device may also be used to identify when a requester arrives at a place providing a service. A device may for example be arranged to display a barcode on its display means which can be read by a sensor.

A device application may be pre-programmed with the requester's personal details and/or preferences so that when the device connects to a place providing a service, that place will obtain information useful in providing the service. Providing such information in advance may save time once the requester has arrived at a place providing the specified service. The requester's request may comprise an identity number allowing the requester's personal details to be recalled from a database.

A piece of software such as an application that can run on the device and connect to it to a queue control unit to request that a requester is placed in a queue for a specified service. The application is arranged to connect the device to one or more places offering the specified service.

According to a further embodiment of the invention the system comprises data storage means for storing information such as information concerning requests, requesters and/or requesters' arrival times. A queue control unit may thereby log and analyze a requester's behaviour and then use this information to optimize the requester's interaction with places offering services to that requester. For example, a requester's actual travel times rather than predicted travel times and the number of times a requester fails to turn up at a place at which he/she is to go to receive a specified service may be stored. Data concerning how long a service actually takes may be stored and used by the queue control unit to better estimate the duration of services.

According to an embodiment of the invention the system comprises map and/or directions providing means to provide the device with a map and/or directions on to get to the place.

According to another embodiment of the invention the device is arranged to enable the requester to pay for a service in advance.

The present invention also concerns a method for providing an expedited specified service. The method comprises the steps of a queue control unit receiving a request for a specified service from a requester having a device via the device, and providing, to the device, place and time information indicating the place to which the requester is to go to receive the specified service and the time at which the requester is to go to the place if he/she wants to be prioritised for receiving the specified service.

Further embodiments of the method are given in the dependent method claims. The present invention further concerns a computer program product that comprises a computer program containing computer program code means arranged to cause a computer or a processor to execute the steps of a method according to any of the embodiments of the invention, stored on a computer-readable medium or a carrier wave.

### BRIEF DESCRIPTION OF THE DRAWINGS

The present invention will hereinafter be further explained by means of non-limiting examples with reference to the appended schematic figures where;

FIG. 1 shows a system according to an embodiment of the invention, and

FIGS. 2-5 show how a method according to an embodiment of the invention may be implemented at a place providing a service.

It should be noted that the drawings have not been drawn to scale and that the dimensions of certain features have been exaggerated for the sake of clarity.

### DETAILED DESCRIPTION OF EMBODIMENTS

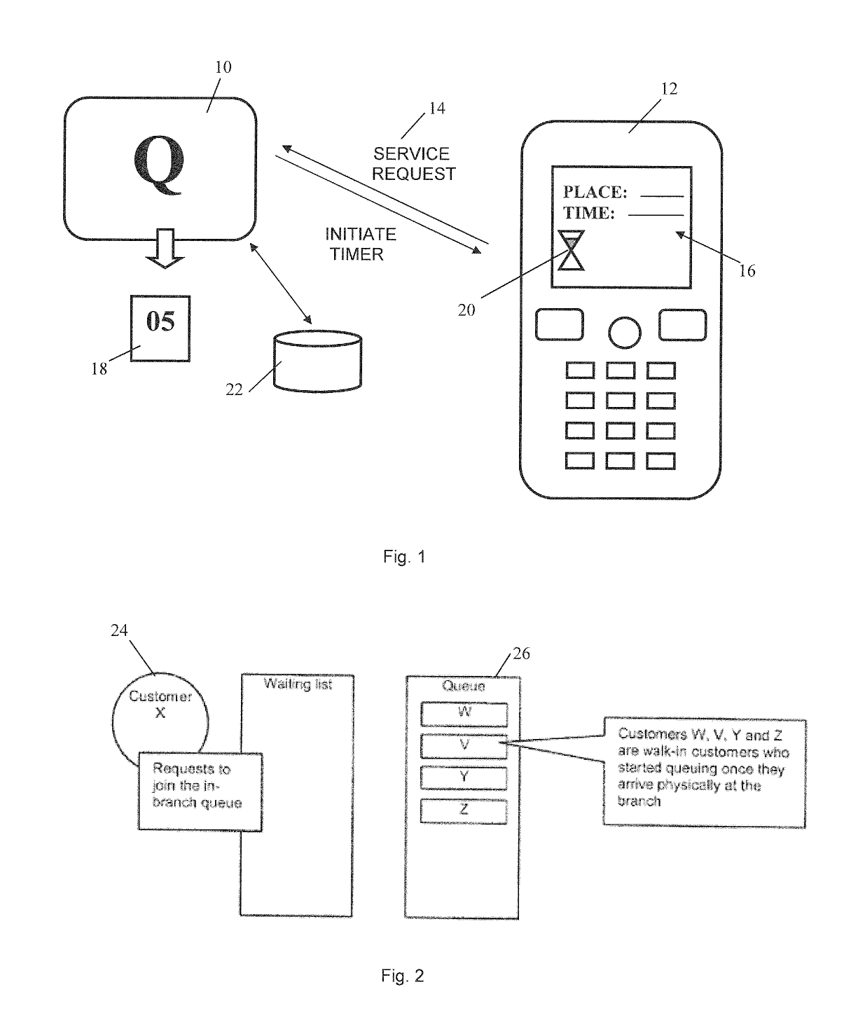

FIG. 1 shows a system comprising a queue control unit 10 and a device 12, namely a mobile telephone, which is arranged to send a request 14 from a requester for a specified service to the queue control unit 10. The queue control unit 12 is arranged to provide, to the device 12, place and time information 16 indicating the place to which the requester is to go to receive the specified service and the time at which the requester is to go to the place if he/she wants to be prioritised for receiving the specified service.

The queue control unit 10 may be located at the place that provides the specified service and may be arranged to receive a request for a specified service from local requesters, for example by issuing a numbered paper ticket 18 to people pressing a button on a ticket dispensing machine. Alternatively, the queue control unit 10 may be located remotely to the place that provides the specified service. The system according to the present invention may for example comprise one or more central queue control units 10 that are arranged to be in communication with at least one place that provides a service.

The device 12 comprises a timer 20, such as a countdown clock represented by a time display, clock face or any other text or graphic image or icon. The timer 20 is arranged to be initiated when the device 12 receives the place and time information to indicate to the requester, i.e. the user of the device for example, how much time he has before he/she should be at the place providing the service that he/she has requested. A device 12 may be arranged to comprise a plurality of such timers 20 to indicate different times, such as the time remaining before the requester has to start to travel to a particular place or places or the time remaining before the requester has to be at the place(s) providing the service(s) that he/she has requested.

The device 12 may comprise location determining means and means to send the location of the device 12 to the queue control unit 10. The queue control unit 10 may be arranged to send a map or directions on how to get to a place providing a service to the device 12. The information concerning the location of the device 12 may be sent to the queue control unit 10 together with the request 14, after sending the request 14, and/or periodically after the device 12 has received the place and time information, or on request from the queue control unit 10. If updated location information is sent to the queue control unit 10, updated maps and directions may be provided.

The device 12 may be arranged to display requestor identifying means, such as a barcode on arriving at the place providing the service so that the requestor can be identified and the device 12 itself is thereby used as a ticket.

The system comprises data storage means 22 for storing information such as information concerning requests, requesters and/or requesters' arrival times.

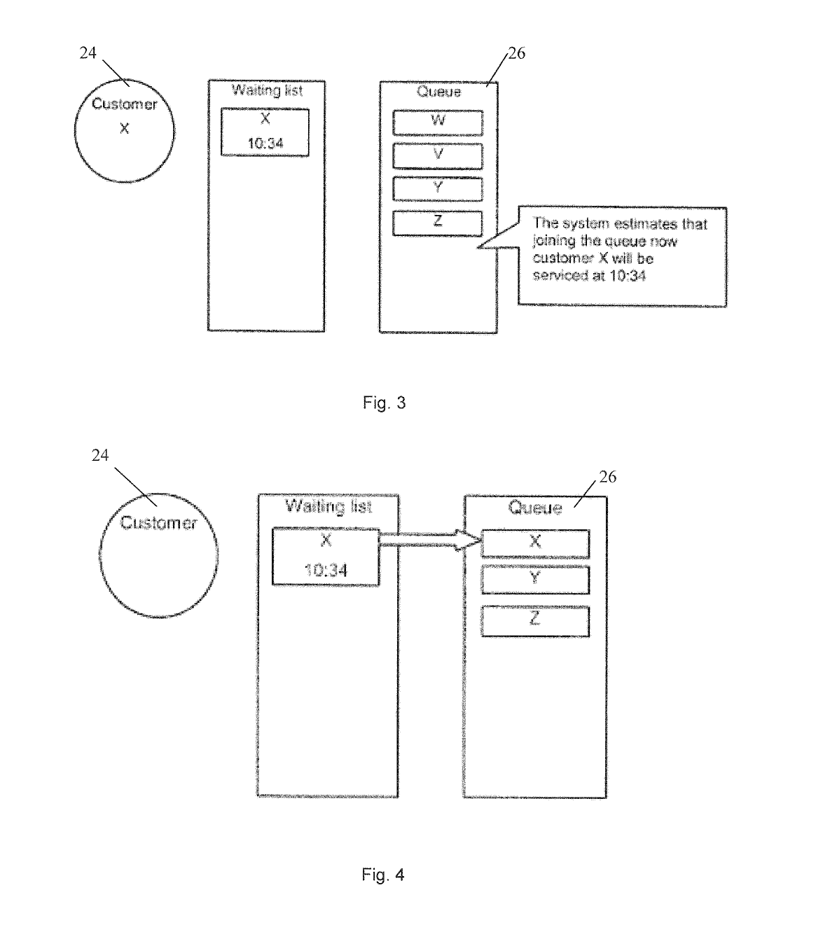

FIGS. 2-5 a method according to an embodiment of the invention may be implemented at a place providing a service. In the steps shown in FIGS. 2 and 3 a requestor X 24 requests a service by sending a request from his/her device 12 to a queue control unit 10, while not at a place providing that service. The system according to the present invention puts the requester in a queue 26 that already contains four other customers V, W, Y. Z. and sends customer X an estimated service time at a particular branch of a place providing that service. The system estimates that the requestor X 24 will be served at 10:34 hrs. The requestor 24 should arrive at that branch at that time in order to be prioritized for that service and be served.

The queue 26 is unpredictable and could move faster or slower than estimated by the queue control unit 10. With reference to FIG. 4, if the requester X 24 arrives at the branch at the appointed time (i.e. at 10:34 hrs.) he/she is placed at the head of the queue 26 so that he/she becomes the next person to be served. FIG. 4 shows that customers V and W have already been served, but customers Y and Z have not.

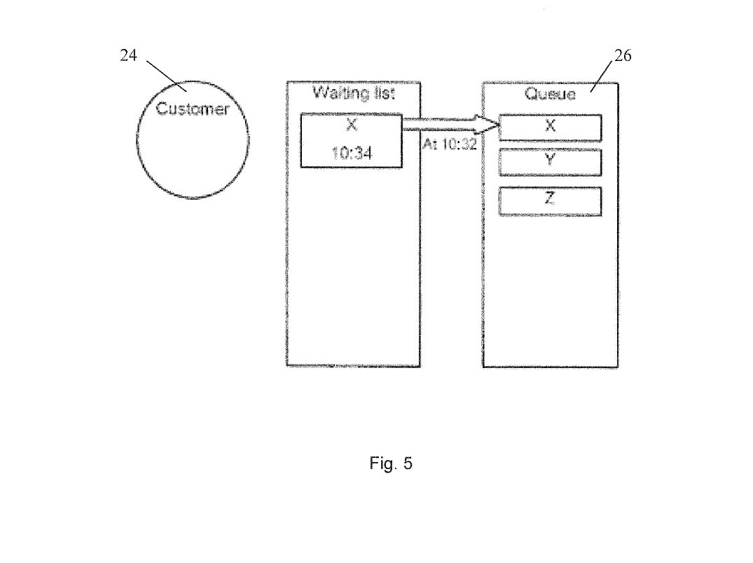

With reference to FIG. 5, if the requester X 24 arrives at the branch before the appointed time (at 10:32 hrs. for example) he/she may also be placed at the head of the queue 26 so that he/she becomes the next person to be served.

If the requester X 24 arrives after the appointed arrival time and if he/she is within a predetermined time of the appointed time (such as within 10 minutes of the appointed time) he/she may also be placed at the head of the queue 26. Alternatively, if the requester X 24 arrives after the appointed arrival time, he/she may be placed at the back of the queue 26.

Further modifications of the invention within the scope of the claims would be apparent to a skilled person.

Alternatively, a system may comprise a queue control unit and a device comprising a timer, such as a countdown clock, whereby the device is arranged to send a request from a requester for a specified service to the queue control unit. The queue control unit is arranged to initiate the timer in the device, for example in response to receiving the request, whereby the timer may indicate to the requester how much time remains before he/she will receive the specified service or the time remaining before he/she has to start to travel to the place providing the service. Such a system does not require contact with a communications network after a queue control unit has initiated the timer. A requester that has received a place in queue will namely be reminded that he/she is to be at a certain place at a certain time by the timer in his/her device irrespective of whether his/her device is in contact with a communications network. Such a solution therefore reduces the amount of traffic on a communication network as compared to a pager systems in which at least one message must be sent to the pager to remind its user of an appointment, and is much less sensitive to problems associated with delays or break downs in a communication network.

Optionally, the queue control unit may also be arranged to provide, to said device, place and time information indicating the place to which said requester is to go to receive said specified service and the time at which said requester is to go to said place if he/she wants to be prioritised for receiving said specified service. Additionally, or alternatively, such a system may comprise any other feature of the system described in this document.

1. A system comprising a queue control unit and a device, wherein a device is arranged to send a request from a requester for a specified service to said queue control unit and said queue control unit is arranged to provide, to said device, place and time information indicating the place to which said requester is to go to receive said specified service and the time at which said requester is to go to said place if he/she wants to be prioritised for receiving said specified service.

2. The system according to claim 1, wherein said queue control unit is also arranged to directly receive a request for a specified service from a requester without a device.

3. The system according to claim 1, wherein said device is a mobile device, such as a such as a mobile telephone, media player, Personal Communications System (PCS) terminal, Personal Data Assistant (PDA), laptop computer or palmtop receiver.

4. The system according to claim 1, wherein said device comprises a timer, such as a countdown clock, that is arranged to be initiated when said device receives said place and time information.

5. System according claim 1, wherein said device comprises location determining means and means to send the location of said device to said queue control unit.

6. The system according to claim 5, wherein said information concerning the location of said device is sent to said queue control unit together with said request, after sending said request, periodically after said device had received said place and time information, or on request.

7. The system according to claim 1, wherein it comprises identifying means to identify said requester when he/she arrives at said place to receive said specified service.

8. The system according to claim 1, wherein it comprises data storage means for storing information such as information concerning requests, requesters and/or requesters' arrival times.

9. The system according to claim 1, wherein it comprises map and/or directions providing means to provide said device with a map and/or directions on to get to said place.

10. A method for providing an expedited specified service, wherein it comprises the steps of
a queue control unit receiving a request for a specified service from a requester having a device via the said device, and
providing, to said device, place and time information indicating the place to which said requester is to go to receive said specified service and the time at which said requester is to go to said place if he/she wants to be prioritised for receiving said specified service.

11. The method according to claim 10, wherein it comprises the step of said queue control unit also receiving a request for a specified service directly from a requester without a device.

12. The method according to claim 10, wherein said device is a mobile device, such as a such as a mobile telephone, media player, Personal Communications System (PCS) terminal, Personal Data Assistant (PDA), laptop computer or palmtop receiver.

13. The method according to claim 10, wherein it comprises the step of initiating a timer, such as a countdown clock, in said device on providing said place and time information to said device.

14. The method according to claim 10, wherein it comprises the step of said queue control unit receiving information concerning the location of said device and determining the place to which said requester is to go to receive said specified service.

15. The method according to claim 14, wherein said information concerning the location of said device is received by said queue control unit at said step of receiving a request for a specified service from a request having a device or before said step of providing place and time information to said device, and/or periodically and/or on request after said step of providing place and time information to said device.

16. The method according to claim 10, wherein it comprises the step of identifying said requester when he/she arrives at said place to receive said specified service.

17. The method according to claim 10, wherein it comprises the step of storing information such as information concerning requests, requesters and/or requesters' arrival times.

18. The method according to claim 10, wherein it comprises the step of providing said device with a map and/or directions on to get to said place.

19. A computer program product, wherein it comprises a computer program containing computer program code means arranged to cause a computer or a processor to execute the steps of a method according to claim 10, stored on a computer-readable medium or a carrier wave.
